(19) United States
(12) Patent Application Publication
(10) Pub. No.: US 2012/0205469 A1
(43) Pub. Date: Aug. 16, 2012

(54) Dual Mode Fuel Injector

(75) Inventors: William Yunbiao Shen, Westmont, IL (US); Keith Steven Schulz, Columbia, SC (US); Joseph Angelino, Poquoson, VA (US)

(73) Assignee: International Engine Intellectual Property Company LLC, Warrenville, IL (US)

(21) Appl. No.: 13/210,981

(22) Filed: Aug. 16, 2011

Related U.S. Application Data
(60) Provisional application No. 61/373,910, filed on Aug. 16, 2010.
(60) Provisional application No. 61/380,458, filed on Sep. 7, 2010.

(51) Int. Cl. F02M 61/10

(52) U.S. Cl. 239/584

(57) ABSTRACT

A fuel injector for an internal combustion engine comprises a fuel intensification section and a needle control section. The fuel intensification section has an inlet and an outlet. The fuel intensification section receives fuel at a first pressure at the inlet and provides fuel at one of the first and second pressures at the outlet. The second pressure is greater than the first pressure. The needle control section has an injector needle and an injector needle control valve. The injector needle has a first position and a second position. The injector needle is disposed in the second position to allow fuel to flow from the fuel injector to the internal combustion engine. The injector needle control valve controls movement of the injector needle. All of the fuel that flows from the fuel injector to the internal combustion engine passes through the fuel outlet of the fuel intensification section.

### RELATED APPLICATIONS

The present application claims priority to U.S. Provisional Patent Application Nos. 61/373,910 filed on Aug. 16, 2010 and 61/380,458 filed on Sep. 7, 2010, which are herein incorporated by reference in its entirety.

### TECHNICAL FIELD

The present disclosure relates to a fuel injector, and more particularly to a fuel injector having the ability to inject fuel at both a fuel accumulator pressure and at an intensified pressure.

### BACKGROUND

Fuel systems for modern diesel engines operate at ever increasing fuel injection pressures. One way to achieve these high fuel injection pressures is to utilize a hydraulically intensified fuel injection system. Such a system may utilize a high-pressure common rail system that provides fuel to each individual injector from a high-pressure accumulator, oftentimes referred to as the “rail” or “common rail.” The injector also receives a high-pressure hydraulic fluid, such as fuel, engine oil, or other hydraulic fluid, that is utilized to drive a piston, or other pressure intensifying system, to increase the pressure of the fuel that leaves the injector to the pressures required by modern diesel engines. Thus, the fuel that is exiting the fuel injector and provided into a cylinder of an engine is at a very high pressure, in some instances a pressure higher than 3000 bar. However, other engine operating conditions do not require this high pressure injection, and thus intensification is not utilized in all operating situations. Previously, such a fuel injector had multiple internal fuel flow passageways in order to provide fuel injections at intensified pressures in some circumstances, and to also be capable of providing fuel injection at the pressure of the common rail. However, such an arrangement increases an ability for fuel leaks to occur within the fuel injector based on providing additional fluid flow paths within the injector. Therefore, a need exists for a fuel injector that allows for both intensified fuel injection events, and rail pressure fuel injection events without providing separate flow paths within the injector for fuel injected during these injection events.

### SUMMARY

According to one embodiment, a fuel injector for an internal combustion engine comprises a fuel intensification section and a needle control section. The fuel intensification section has a fuel intensification piston and a fuel intensification control valve. The fuel intensification piston has a first position and a second position. Movement of the fuel intensification piston from the first position to the second position increases a pressure of fuel within the injector. The fuel intensification control valve controls movement of the fuel intensification piston from the first position to the second position. The needle control section has an injector needle and an injector needle control valve. The injector needle has a first position and a second position. Fuel flows from the fuel injector to the internal combustion engine with the injector needle disposed in the second position. The injector needle control valve controls movement of the injector needle from the first position to the second position. All of the fuel that flows from the fuel injector to the internal combustion engine passes through the fuel intensification section irrespective of a pressure of the fuel injection.

According to another embodiment, a fuel injector for an internal combustion engine comprises a fuel intensification section and a needle control section. The fuel intensification section has an intensification chamber, a fuel intensification piston, and a fuel intensification control valve. The fuel intensification piston has a first position and a second position. Movement of the fuel intensification piston from the first position to the second position increases pressure of fuel within the intensification chamber. The movement of the fuel intensification piston is controlled by the fuel intensification control valve. The needle control section is in fluid communication with the intensification chamber. All of the fuel that enters the needle control section passes through the intensification chamber. The fuel exiting the intensification chamber is provided at a first pressure to the needle control section when the fuel intensification piston is disposed in the first position. The fuel exiting the intensification chamber is provided at a second pressure to the needle control section when the fuel intensification piston is disposed in the second position. The first pressure is greater than the second pressure.

According to a further embodiment, a fuel injector for an internal combustion engine comprises a fuel intensification section and a needle control section. The fuel intensification section has an inlet and an outlet. The fuel intensification section receives fuel at a first pressure at the fuel inlet and provides fuel at one of the first pressure and a second pressure at the outlet. The second pressure is greater than the first pressure. The needle control section has an injector needle and an injector needle control valve. The injector needle has a first position and a second position. The injector needle is disposed in the second position to allow fuel to flow from the fuel injector to the internal combustion engine. The injector needle control valve controls movement of the injector needle from the first position to the second position. All of the fuel that flows from the fuel injector to the internal combustion engine passes through the fuel outlet of the fuel intensification section.

### BRIEF DESCRIPTION OF THE DRAWINGS

FIG. 1 is schematic view of a portion of a fuel system for an internal combustion engine one embodiment.

FIG. 2 is a first sectional schematic view of a fuel injector according to one embodiment.

FIG. 3 is a second sectional schematic view of the fuel injector of FIG. 2.

### DETAILED DESCRIPTION

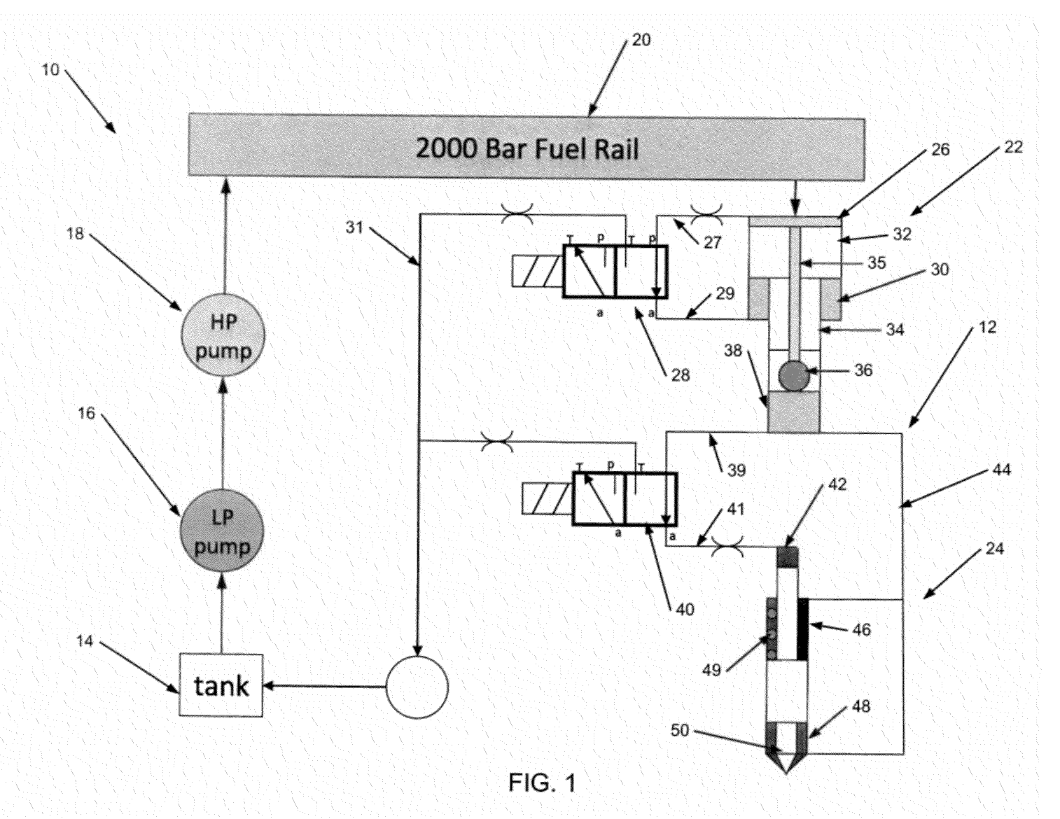

FIG. 1 shows a portion of a fuel system 10 for a vehicle according to one embodiment. The fuel system 10 comprises a fuel injector 12 adapted to inject fuel into a cylinder of an internal combustion engine of the vehicle. The fuel system 10 also comprises a fuel reservoir or fuel tank 14 adapted to store fuel to be combusted within the engine after being injected by the fuel injector 12. A low pressure fuel pump 16 is adapted to pump fuel from the fuel tank 14 to a high pressure pump 18. The high pressure pump 18 compresses the fuel received from the low pressure pump 16 to a pressure that the fuel will be provided to a fuel accumulator 20. The fuel accumulator 20, also referred to as a rail, or a common rail, is adapted to supply fuel to one or more fuel injector of an engine, such as the fuel injector 12 shown in FIG. 1.

It is contemplated that the high pressure pump 18 may deliver fuel to the fuel accumulator 20 at a pressure of from about 1000 bar to about 3000 bar. The fuel accumulator 20 maintains the pressure of the fuel from the high pressure pump 18 and is in fluid communication with the fuel injector 12.

The fuel injector 12 comprises an intensification section 22 and a needle control section 24. The intensification section 22 has a first fuel receiving section 26. The first fuel receiving section 26 is disposed in fluid communication with the fuel accumulator 20. A fuel intensification control valve fluid line 27 provides fuel from the first fuel receiving section 26 to a fuel intensification control valve 28. The fuel intensification control valve 28 is a three way valve. The fuel intensification control valve 28 regulates the flow of fuel from the first fuel receiving section 26 to a second fuel receiving section 30 of the intensification section 22 via an intensification piston fuel line 29. The intensification piston fuel line 29 allows fuel to flow into and out of the second fuel receiving section 30. The flow of fluid into and out of the second fuel receiving section 30 control movement of a fuel intensification piston 32.

When fuel is present in the second fuel receiving section 30, the fuel intensification piston 32 is in a first position, as shown in FIG. 1, where the fuel intensification piston 32 is not moving downward to increase the pressure of the fuel in the intensification section 22 of the fuel injector 12. When the fuel intensification control valve 28 is disposed in a second position, the fuel in the second fuel receiving section 30 flows back to the fuel intensification control valve 28 and out a drain line 31 back to the fuel tank 14. When the second fuel receiving section 30 does not contain fuel, the pressure of the fuel within the first fuel receiving section 26 causes the fuel intensification piston 32 to move downward.

A fuel intensification plunger 34 is connected to the fuel intensification piston 32 and moves in conjunction with the fuel intensification piston 32. As will be explained in additional detail below, the fuel intensification plunger 34 compresses fuel in an intensification chamber 38 to raise the pressure of the fuel in the intensification chamber 38.

An intensification chamber fuel line 35 is disposed between the first fuel receiving section 26 and the intensification chamber 38. A check valve 36 may be disposed at one end of the intensification chamber fuel line 35 to ensure that fuel may not flow from the intensification chamber 38 towards the first fuel receiving section 26. As the fuel intensification plunger 34 moves downwards, the fuel in the intensification chamber 38 is compressed, thereby raising the pressure of the fuel in the intensification chamber.

As shown in FIG. 1, the fuel intensification plunger 34 has a diameter less than the fuel intensification piston 32. It is contemplated that the fuel intensification plunger 34 and the intensification chamber 38 are sized so that fuel within the intensification chamber 38 is raised to a pressure about double that of the pressure in the fuel accumulator 20. However, based on various pressure losses within the fuel injector 12, the actual injection pressure of the fuel may be significantly less than double the pressure of the fuel in the fuel accumulator 20.

Fuel from the intensification chamber 38 is provided to the needle control section 24. The fuel is provided via a control valve fuel line 39 to a needle control valve 40. The needle control valve 40 controls the flow of fuel from the intensification chamber 38 to a first needle control reservoir 42 via a needle reservoir fuel line 41. Fuel from the intensification chamber 38 is also provided to a second needle control reservoir 46 via a fuel delivery line 44. The fuel delivery line 44 also provides fuel to an injector needle reservoir 48 disposed adjacent an injector needle 50 of the injector 12. The fuel in the injector needle reservoir 48 is injected into the engine when the injector needle 50 moves upward allowing the fuel to flow from the needle reservoir 48.

In order to allow the injector needle 50 to be released and moved upward, the needle control valve 40 opens, allowing fuel to flow from the first needle control reservoir 42 to the drain line 31. As the first needle control reservoir 42 empties, the pressure of fuel causes the needle 50 to move upward and compress a biasing member 49, such as a spring, within the second needle control reservoir 46. As the fuel exits the needle reservoir 48, the biasing member 49 begins to return the needle 50 to a seated position that prevent fuel flow from the injector 12, and the needle control valve 40 may also be positioned to allow fuel to flow to the first needle control reservoir 42. The flow of fuel back to the first needle control reservoir 42 and the pressure applied to the needle 50 by the biasing member 49 and the fuel in the second needle control reservoir 46 lower the needle 50 back to a seated position that prevents the flow of fuel from the needle reservoir 48.

The fuel injector 12 is a dual mode fuel injector in that fuel can be injected into the engine at either the pressure within the fuel accumulator 20, by not activating the fuel intensification piston 32 and the fuel intensification plunger 34, or the fuel may be injected at an intensified pressure by activating the fuel intensification piston 32 and the fuel intensification plunger 34. When fuel is being injected at the pressure of the fuel accumulator 20, the fuel still passes through the intensification chamber 38, but the pressure of the fuel is not raised within the intensification section 22.

When the fuel intensification piston 32 and the fuel intensification plunger 34 are activated, the pressure of the fuel in the intensification chamber 38 is elevated, and provided to the needle control section 24 for injection into the engine. The pressure of the fuel within the needle reservoir 48 for injection into the engine is thus generally identical to the pressure of the fuel within the intensification chamber 38 and the first and second needle control reservoirs 42, 46.

Thus, all fuel that is injected by the fuel injector 12 into the engine passes through the intensification chamber 38. This simplifies the flow path of the fuel within the injector 12 compared to prior dual mode fuel injector, which would provide a bypass around the intensification section 22 when fuel is to be injected at the pressure of the fuel accumulator 20. The design of the present embodiment reduces possible leak points within the injector 12 by eliminating these bypass flow paths.

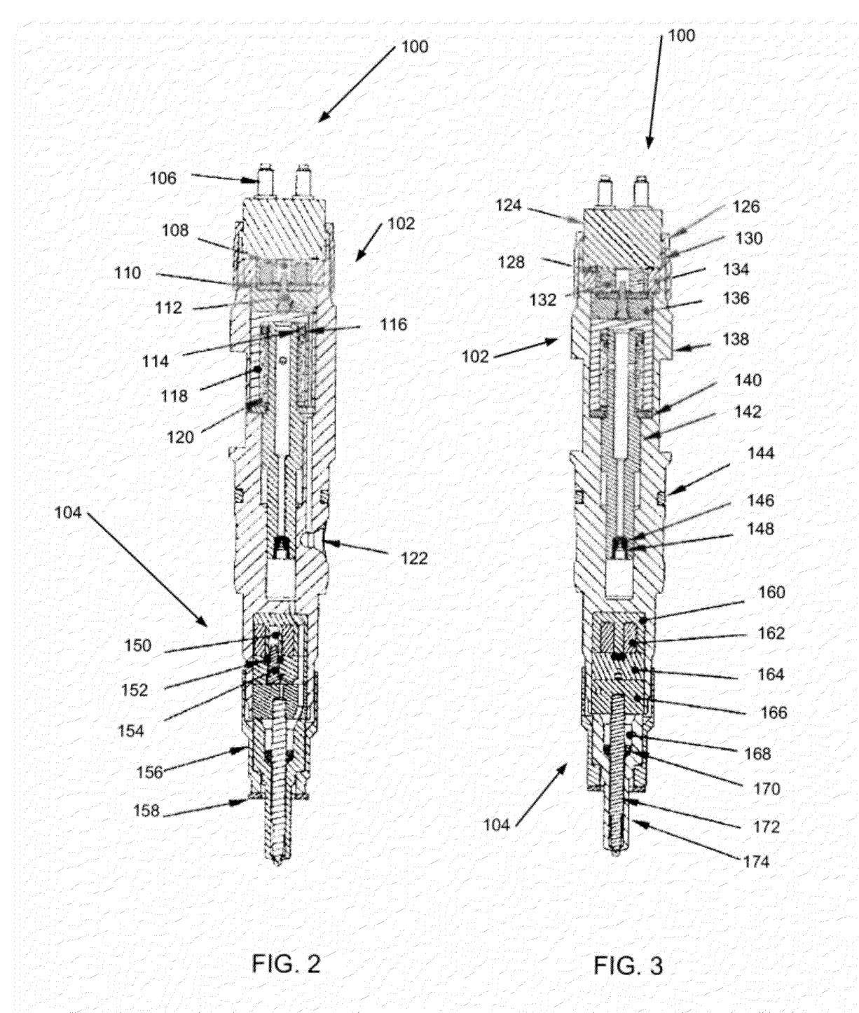

Turning now to FIGS. 2 and 3, cross sectional views taken through generally normal planes formed through a longitudinal axis of a fuel injector 100 are shown. The injector 100 comprises an intensification section 102 and a needle control section 104.

Structurally, the injector 100 comprises an injector body 138 and a nozzle 174 that are held together by a cone nut 156. An injector cap 126 may be connected to the injector body 138. An o-ring 130 may form a seal between the injector cap 126 and the injector body 138.

The intensification section 102 has electrical posts 106 in a terminal 124 to provide an electrical connection to the injector 100. The electrical connection established by the posts are used to control an intensification control valve 112 and a needle control valve 154 as described in more detail below.

The electrical posts 106 provide electrical power to an intensification control valve armature 110 and an intensification control valve pole 128 and an intensification control valve coil 132 within a terminal 124 in order to control the position of the intensification control valve 112. When electrical power is provided, the intensification control valve 112 is moved within an intensification control valve body 136 to allow movement of a intensification piston and plunger 142 to cause the pressure of fuel delivered by the fuel injector 100 to be increased from a pressure within a fuel accumulator. When electrical power is discontinued, an intensification control valve spring 108 moves the intensification control valve 112 back to a first position where intensification does not occur. A retainer 134 is provided to fix the position of the intensification control valve 112 between the terminal 124 and the injector body 138.

In order to increase the pressure of fuel within the intensification section 102, fuel that enters the injector from a fuel accumulator via a fuel inlet 122 and will enter a reservoir above a plunger head 116 and below a piston portion of the intensification piston and plunger 142. Fuel also is provided to reservoir below a distal end of the intensification piston and plunger 142. A check valve 148 is provided proximate the distal end of the intensification piston and plunger 142 to prevent the flow of fuel towards a proximal end of the intensification piston and plunger 142. A check valve plate 146 limits the movement of the check valve 148 to prevent fuel flow towards a proximal end of the intensification piston and plunger 142. The intensification control valve 112 opens, and the fuel below the piston portion of the intensification piston and plunger 142 drains, allowing the intensification piston and plunger 142 to move downward, increasing the pressure of the fuel within the reservoir below a distal end of the intensification piston and plunger 142.

The intensification control valve 112 closes, and an intensification spring 120 helps to move the intensification piston and plunger 142 upward. The intensification spring 120 is disposed between a spring seat 140 and a plunger head 116. A spring cage 118 within the injector body 138 additionally constrains the intensification spring 120. A retaining clip 114 also helps to retain the plunger head 116.

The electrical posts 106 also provide electrical power to a needle control armature 152 and an needle control pole 160 and a needle control coil 162 to control the position of a needle control valve 154. When electrical power is provided, the needle control valve 154 is moved within a needle control valve body 164 to allow movement of an injector needle 172 to allow fuel to be injected from the nozzle 174 of the injector 100. When electrical power is discontinued, a needle control valve spring 150 helps move the needle control valve 154 back to a first position where fuel injection does not occur.

In order to inject fuel from the nozzle 174, fuel that enters the needle control section 104 from the intensification section, whether at an intensified pressure or a fuel accumulator pressure, is provided to a reservoir above a needle body 166 and proximate a distal portion of the needle 172 near the nozzle 174. The needle control valve 154 opens, and the fuel in the reservoir above a needle body 166 drains, allowing the needle 172 to move upward, so that fuel may flow from the nozzle 174.

The needle control valve 154 closes, and a needle spring 168 helps to move the needle 172 downward to seal the nozzle 174. The needle spring 168 is disposed between a needle spring guide 172 and the needle body 166.

In order to reduce leakage of fuel around the injector 100, an injector body o-ring 144 is disposed around the injector body 138. Additionally, a gasket 158 may be provided proximate a distal end of the cone nut 156.

The injector 100 is a dual mode fuel injector in that it is capable of injecting fuel at either a pressure within a fuel accumulator that is fed to the injector 100, or at an intensified pressure generated by movement of the intensification piston and plunger 142. It is contemplated that all of the fuel injected by the fuel injector 100 passes through the intensification section 102, regardless of whether the fuel is injected at an intensified pressure.

What is claimed is:

1. A fuel injector for an internal combustion engine comprising:
a fuel intensification section having a fuel intensification piston and a fuel intensification control valve, the fuel intensification piston having a first position and a second position, whereby movement of the fuel intensification piston from the first position to the second position increases pressure of fuel within the injector, the fuel intensification control valve controlling movement of the fuel intensification piston from the first position to the second position; and
a needle control section having an injector needle and an injector needle control valve, the injector needle having a first position and a second position, the injector needle being disposed in the second position allowing fuel to flow from the fuel injector to the internal combustion engine, the injector needle control valve controlling movement of the injector needle from the first position to the second position, wherein all fuel flowing from the fuel injector to the internal combustion engine passes through the fuel intensification section irrespective of a pressure of the fuel injection.

2. The fuel injector of claim 1, wherein the fuel intensification section further has a fuel injection plunger connected to the fuel injection piston, the fuel injection plunger contacting fuel within an intensification chamber to increase the pressure of the fuel within the injector.

3. The fuel injector of claim 1, wherein the fuel intensification section further has a first fuel receiving section disposed above the fuel intensification piston and a second fuel receiving section disposed below the fuel intensification piston.

4. The fuel injector of claim 3, wherein the fuel intensification control valve controls an amount of fuel within the second fuel receiving section.

5. The fuel injector of claim 3, wherein the fuel intensification section further has an intensification chamber fuel line disposed between the first fuel receiving section and a fuel intensification chamber.

6. The fuel injector of claim 5, wherein the fuel intensification section further has a check valve disposed in the intensification chamber fuel line, the check valve restricting the flow of fuel from the fuel intensification chamber to the first fuel receiving section.

7. The fuel injector of claim 1, wherein the needle control section further has a needle reservoir, the needle reservoir being disposed in fluid communication with a fuel intensification chamber of the fuel intensification section.

8. The fuel injector of claim 1, wherein the needle control section further has a first needle control reservoir and a second needle control reservoir, the first needle control reservoir being disposed above the injector needle.

9. The fuel injector of claim 8, wherein the needle control valve controls an amount of fuel within the first needle control reservoir.

10. The fuel injector of claim 8, wherein the first needle control reservoir and the second needle control reservoir are in fluid communication with the fuel intensification chamber.

11. The fuel injector of claim 1, wherein the needle control section further has a biasing member adapted to bias the injector needle to the first position.

12. The fuel injector of claim 1, wherein the fuel intensification control valve is a three way valve.

13. The fuel injector of claim 1, wherein the needle control valve is a three way valve.

14. A fuel injector for an internal combustion engine comprising:
a fuel intensification section having an intensification chamber, a fuel intensification piston, and a fuel intensification control valve, the fuel intensification piston having a first position and a second position, whereby movement of the fuel intensification piston from the first position to the second position increases pressure of fuel within the intensification chamber, the movement of the fuel intensification piston being controlled by the fuel intensification control valve; and
a needle control section in fluid communication with the intensification chamber such that all fuel that enters the needle control section passes through the intensification chamber; and
wherein the fuel exiting the intensification chamber being provided at a first pressure to the needle control section when the fuel intensification piston being disposed in the first position, and the fuel exiting the intensification chamber being provided at a second pressure to the needle control section when the fuel intensification piston being disposed in the second position, the first pressure being greater than the second pressure.

15. The fuel injector of claim 14, wherein the needle control section further has an injector needle and an injector needle control valve, the injector needle having a first position and a second position, the injector needle being disposed in the second position allowing fuel to flow from the fuel injector to the internal combustion engine, the injector needle control valve controlling movement of the injector needle from the first position to the second position.

16. The fuel injector of claim 14, wherein the fuel intensification section further has a fuel injection plunger connected to the fuel injection piston, the fuel injection plunger contacting fuel within an intensification chamber to increase the pressure of the fuel from the second pressure to the first pressure.

17. The fuel injector of claim 16, wherein the fuel injection piston has a larger diameter than the fuel injection plunger.

18. A fuel injector for an internal combustion engine comprising:
a fuel intensification section having a fuel inlet and a fuel outlet, the fuel intensification section receiving fuel at a first pressure at the fuel inlet and providing fuel at one of the first pressure and a second pressure at the fuel outlet, the second pressure being greater than the first pressure; and
a needle control section having an injector needle and an injector needle control valve, the injector needle having a first position and a second position, the injector needle being disposed in the second position allowing fuel to flow from the fuel injector to the internal combustion engine, the injector needle control valve controlling movement of the injector needle from the first position to the second position, wherein all fuel flowing from the fuel injector to the internal combustion engine passes through the fuel outlet of the fuel intensification section.

19. The fuel injector of claim 18, wherein the fuel intensification section further has a fuel intensification piston having a first position and a second position, whereby movement of the fuel intensification piston from the first position to the second position increases pressure of fuel from the first pressure to the second pressure.

20. The fuel injector of claim 19, wherein the movement of the fuel intensification piston being controlled by a fuel intensification control valve.
